(19) United States
(12) Patent Application Publication
(10) Pub. No.: US 2014/0108601 A1
(43) Pub. Date: Apr. 17, 2014

(54) SYSTEM AND METHOD FOR CONTENT PERSONALIZATION USING FEEDBACK DATA

(71) Applicant: IPerceptions Inc., Montreal (CA)

(72) Inventors: Audry LAROCQUE, Mont-Royal (CA); Lane COCHRANE, Kirkland (CA); Martin ROY, Drummondville (CA)

(73) Assignee: IPerceptions Inc., Montreal (CA)

(21) Appl. No.: 14/050,443

(22) Filed: Oct. 10, 2013

Related U.S. Application Data
(60) Provisional application No. 61/712,617, filed on Oct. 11, 2012.

(51) Int. Cl. H04L 29/08

(52) U.S. Cl. CPC H04L 67/22
USPC 709/217

(57) ABSTRACT

The present method and system provide personalized web content to user devices under control of a user. In one alternative, the method comprises receiving a request to visit a website from a remote computer hosting a web browser; exchanging data with the remote computer to obtain a recognisable identifier from the remote computer; after reception of the recognisable identifier, retrieving from a personalization database a personalization parameter associated with said identifier; generating, according to a database of web contents and the personalization parameter, a personalized website visit content comprising one of: 1) a different HTML document, 2) a different Cascading Style Sheet (CSS), and 3) a different web content to be provided according to the HTML document, than a non-personalized webpage; and transmitting the personalized website visit content to the remote computer.

### FIELD OF THE INVENTION

The present invention relates to the field of content management and of web survey conduct; and more particularly to content personalization using web survey data.

### BACKGROUND

Nowadays, in the context we live in, it is very important for corporations to understand their patrons, and even more to identify the potential intent of their patrons in relation with their brand, services and products. Inaccurate identification of patron intents may result in great losses, for instance loss of sales, inaccurate responses to the needs of the patrons, loss of fidelity of the patrons to the brand, etc. Accordingly, any tool to increase the corporate understanding of their patrons, and the validity level associable to this knowledge, has important value for corporations.

The same applies to tools used to interact with these patrons. The more efficient they are, the higher the chances for monetizing any interaction with these patrons. Accordingly, evaluation tools are necessary to establish the efficiently of the tools used to interact with the patrons, including tools used to evaluate websites.

In order to optimize the outcome associated with web sites, content management software and hardware has been developed in order to provide more variable content and format than with strictly HTML-coded web pages. However, these tools do not currently provide the desired level of personalization of webpages based on information on visitors.

Currently the most commonly used tools to acquire information on website visitors, i.e. understanding the level of success of a website, consist in the following: (1) web analytics tools such as Google Analytics, (2) survey tools, and (3) session recording tools, also known as session replay processes. While the first provides the tools to follow the actions performed by the visitors of a website (therefore responds to the WHAT question), it fails to provide tools to understand the reasons for a visitors not completing a task (the WHY question) such as not being able to complete a purchase. The second one, while being a good tool to understand the reasons for a visitor for not having completed the task lacks to provide solutions to transform this knowledge into action. The third one, as good as it is to understand the actions of a visitor, remains, as the first tool, based on actions performed by visitors of the website.

Therefore, none of these solutions alone provide a way to improve in a personalized fashion the experience a visitor will get from a visit of a website in order to optimize the odds of the visitor either coming back later or that the visit results in an action such as a purchase.

### SUMMARY

According to a first alternative, the invention takes form of a method performed on a processor-based web server. The method comprises a request processing component receiving, from a remote user device hosting a web browser, a request to visit a website. The method comprises a communication component exchanging data with the remote user device to obtain a recognisable identifier from the remote user device. The method comprises after reception of the recognisable identifier, a content management retrieving from a personalization database a personalization parameter associated with the recognisable identifier. The method comprises the content management component generating, according to a database of web contents and the personalization parameter, a personalized website visit content comprising one of: 1) a different HTML document, 2) a different Cascading Style Sheet (CSS), and 3) a different web content to be provided according to the HTML document, than a non-personalized webpage. The method further comprises the communication component transmitting the personalized website visit content to the remote user-device.

According to another alternative, a web-server-implemented method is provided. The web-server implemented method comprises similar steps as the above method.

According to another alternative, a computer program product comprises a computer readable memory storing computer executable instructions thereon that when executed by a web server processor, perform similar steps as the above method.

According to another alternative, the invention takes form of a method performed on a processor-based survey server. The method comprises a data collection component of the survey server receiving survey participation data in which a survey participant has provided opinions on an experience of visit of a website from a remote user device under control of a survey participant. The method comprises an analytic component of the survey server processing the survey participation data to generate a personalization parameter to be associated with the survey participant. The method further comprises a communication component of the survey server transmitting to a web server, which is responsible of visits of the website and which comprises a content management component, the personalization parameter with an identification of either a) the user device which transmitted the survey participation data, b) identification of the browsing session to which the survey participation data pertains, and c) identification of the user who participated in the survey.

According to another alternative, a web-server-implemented method is described. The method comprises similar steps as the above method.

According to another alternative, a computer program product comprises a computer readable memory storing computer executable instructions thereon that when executed by a web server processor performs similar steps as the above method.

According to another alternative, the invention takes the form of a survey conducting system comprising: a processor; a communication interface for communicating with remote processor-based devices through a communication network; and memory storing one or more databases, and program code. The program code, when processed by the processor, results in the execution of a survey participation collection component that receives from remote processor-based devices under control of survey participants survey participation data, the survey participation data pertaining to visits of a website and stores the survey participation data in a survey database. The program code, when processed by the processor, results in the execution of a personalization analytic component that processes the survey participation data, generates a personalization parameter to be associated with the survey participant who provided the survey participation data accordingly and stores the personalization parameter in a personalization database. The program code, when processed by the processor, further results in the execution of a communication component that communicates to the web server responsible for providing visits of the website the personalization parameter along an identifier usable by the web server to identify the survey participant.

### BRIEF DESCRIPTION OF THE DRAWINGS

In the appended drawings:

FIG. 1 is a schematic illustration of the environment to which the invention pertains;

FIG. 2a is a schematic illustration of the user device illustrated on FIG. 1;

FIG. 2b is a schematic illustration of the runtime environment provided by the web browser component hosted by the user device illustrated on FIG. 1 and FIG. 2a;

FIG. 3 is a schematic illustration of the web server illustrated on FIG. 1;

FIG. 4 is a schematic illustration of the survey server illustrated on FIG. 1;

FIG. 5 is a schematic of signal exchange between the components illustrated on FIG. 1 according to at least one alternative;

FIG. 6 is a schematic illustration of the components taking place in the generation of a personalized webpage;

FIG. 7 is a flow chart illustrating, according to at least one alternative, steps performed by a user device;

FIG. 8 is a flow chart illustrating, according to at least one alternative, additional steps performed by a user device in relation with the conduct of a survey;

FIG. 9 is a flow chart illustrating, according to at least one alternative, steps performed by a web server; and

FIG. 10 is a flow chart illustrating, according to at least one alternative, steps performed by a survey server.

### DETAILED DESCRIPTION

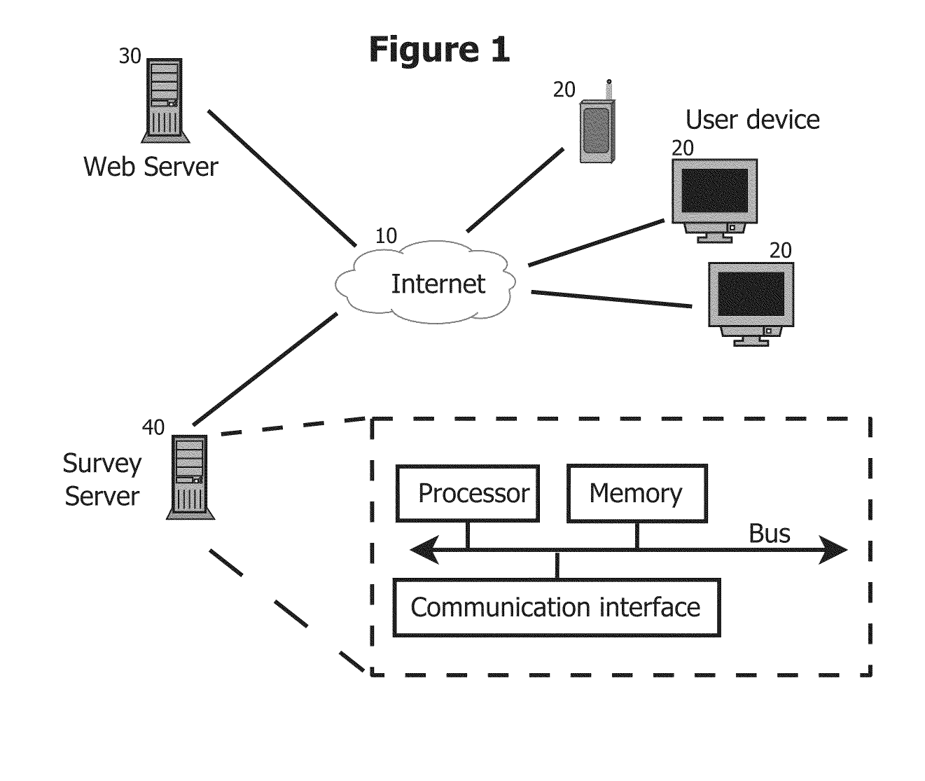

Referring to FIG. 1, a process involves in combination processor-based devices such as a user device 20 hosting a web client component, a web server 30 comprising a Web Content Management (WCM) component, and a survey server 40. The different devices which participate in the process are in communication over a communication network, such as the Internet 10 or a plurality of networks linked or bridged electronically, optically or wirelessly and permitting communication between the different devices.

For the purpose of the present disclosure, the method and system will be depicted in relation with the above-described environment. One must understand that this environment is provided to facilitate the description of different realizations; it is not intended to limit the possible realizations to the described environment. Furthermore, optional devices (not illustrated) may also participate in one of more realizations. Examples of optional devices include a web analytic server and a tag management server.

In the above-described environment, a method is performed on a processor-based device under control of a user, hereinafter called a user device. Exemplary illustrations of such user devices comprise desktop computers, laptop computers, tablets such as iPad™ by Apple, smartphones and personal digital assistants (PDAs) which all share the characteristics of being able to host a web client, such as a web browser, and to communicate with remote devices over a network. Other devices not listed, which share similar characteristics regardless their technical purpose (purpose-specific such as smart televisions and appliances for instance), are also intended to be covered by the expressions “processor-based devices” and “user devices”.

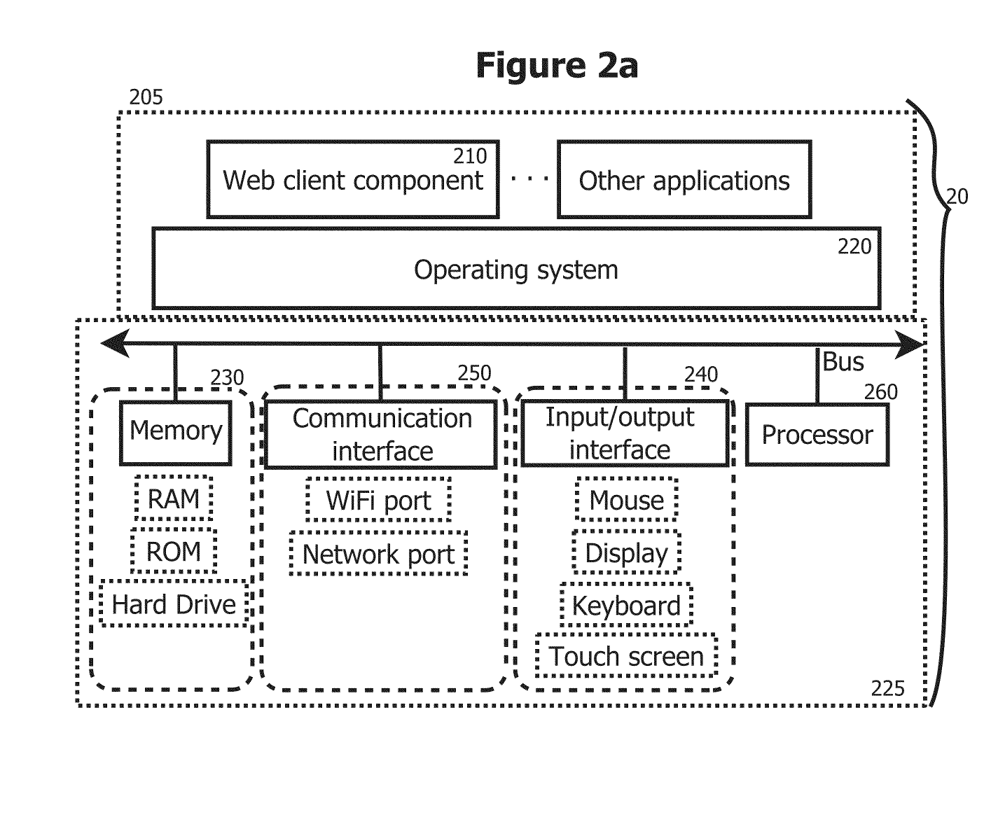

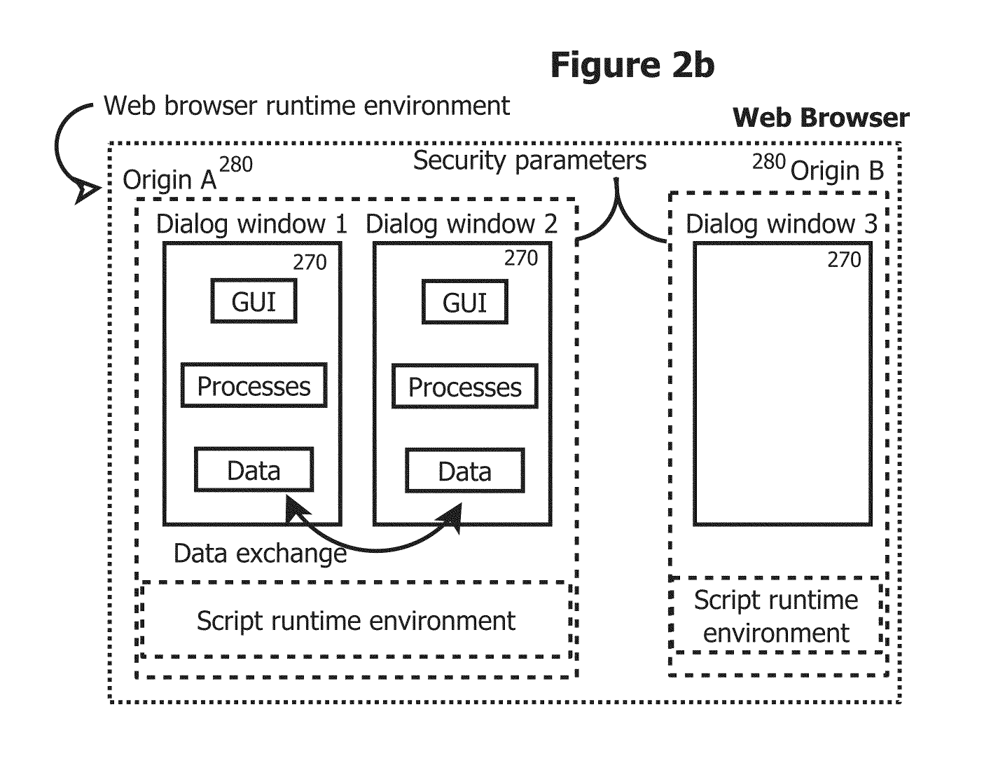

FIG. 2a illustrates an example of a user device 20 hosting a web client component 210. The user device 20 comprises hardware components 225 and software components 205 resulting from codes stored on memory 230, when processed generating the software components 205. As illustrated, a web client component 210 is a component hosted by the user device 20. The web client component 210 may either be manufactured with the user device 20, or the web client component 210 may be installed later. Illustrations of web client components 210 may consist in a web browser such as Microsoft Internet Explorer™, Google Chrome™ Apple Safari™ or Mozilla Firefox™ to list a few. Other web client components 210, usually web client components 210 customized for specific tasks and/or processes and designed to communicate with specific servers, may be available such as those developed under the Adobe Integrated Runtime (AIR) or Windows Runtime (WinRT) environment. The illustrated user device further comprises as hardware components 225, a processor 260, an operating system 220, memory 230, an input/output interface 240 and a communication interface 250 necessary to communicate over a network. The web client component 210 is designed to interact with the hardware components 225 in a functional manner, to access memory for reading and writing functions, to communicate with remote processor-based devices, display information and receives input from the user for instance trough keyboard and mouse controls, etc.

The exemplary web client component 210, illustrated on FIG. 2b, is a web browser designed to access websites, by exchanging data packets with web servers, and downloading and processing web content, such as HTML documents, provided by the web servers. Therefore, the web browser provides the user of the device access to webpages. The web browser is further adapted to provide the necessary runtime environment for processes to be performed when HTML documents feature embedded instructions (also called scripts). The web browser is also adapted to apply security policies restrictions to apply in relation with the provided runtime environment. The security policies for instance limit accessibility of information and processes according to origin identification, therefore isolating data relative to a dialog window with respect to one origin from another dialog window (and associated processes) with respect to another origin. The web browser is further designed to store in the user device memory codes to be used according to runtime environment policies, such as scripts and cookies. In relation with the user interface the web browser provides, one or more dialog windows 270 according to which processes are performed in relation with a domain session and/or origin identification 280. The dialog windows 270 are either or not part of the same browsing session, based on the domain they are communicating with. Origin identification 280 establishes a security parameter, isolating information relative to one browsing session from another browsing session based on the origin identification rather than graphical presentation in the web browser interface.

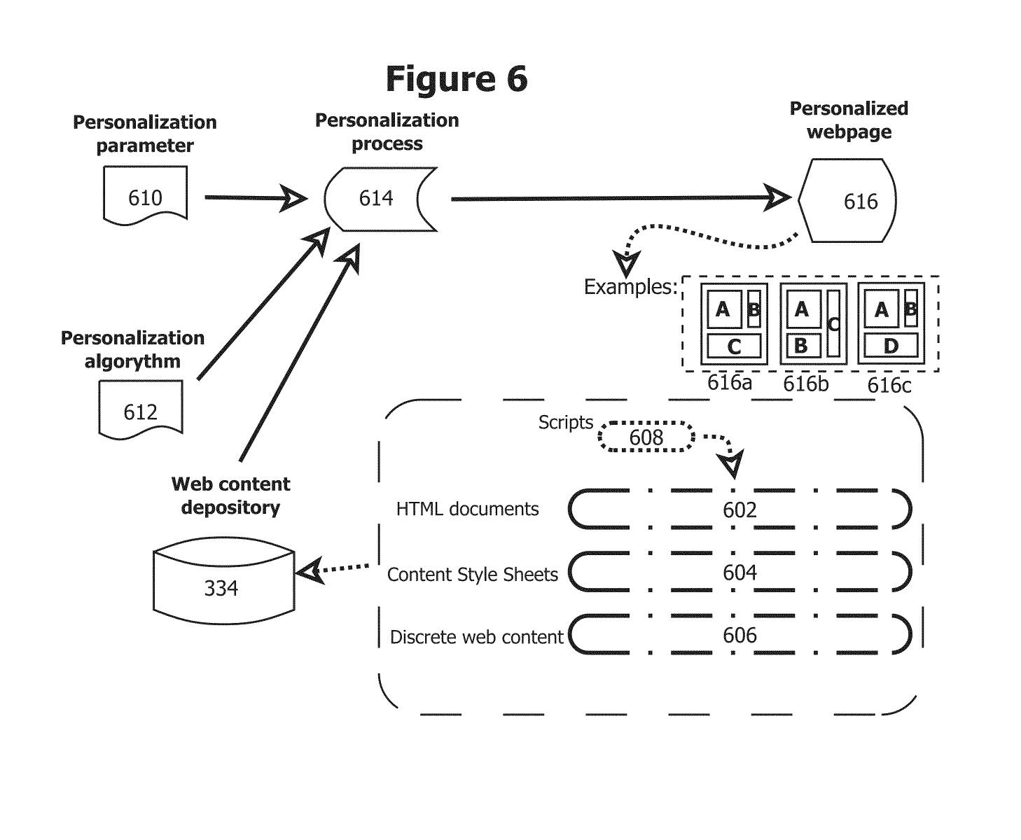

Web browsers are instructions executed by the processor 260. During the executions of the web browsers instructions, the processor 260 may have to access the memory 230, use the communication interface 250 to send and receive data packets, and rely on the input/output interface 240 to obtain inputs from the user, display web pages on the display, etc. Upon visit of a website, the content received from the corresponding web server to generate and display the webpages, as illustrated on FIG. 6, includes of: 1) HTML documents 602, 2) Content Style Sheets 604 capable of providing display layouts and rules used to determine the layout for generating the webpage to be displayed, and 3) discrete web content 606 to be integrated in the displayed webpage independently from the webpage structure provided by the HTML document 602 and the Content Style Sheet 604. Examples of discrete web contents include text elements, images, sounds, videos and animations to list a few. According to this definition, website visit content must include at least one HTML document, and may include a Content Style Sheet and zero to multiple discrete web contents to be integrated in the webpage(s) to be displayed.

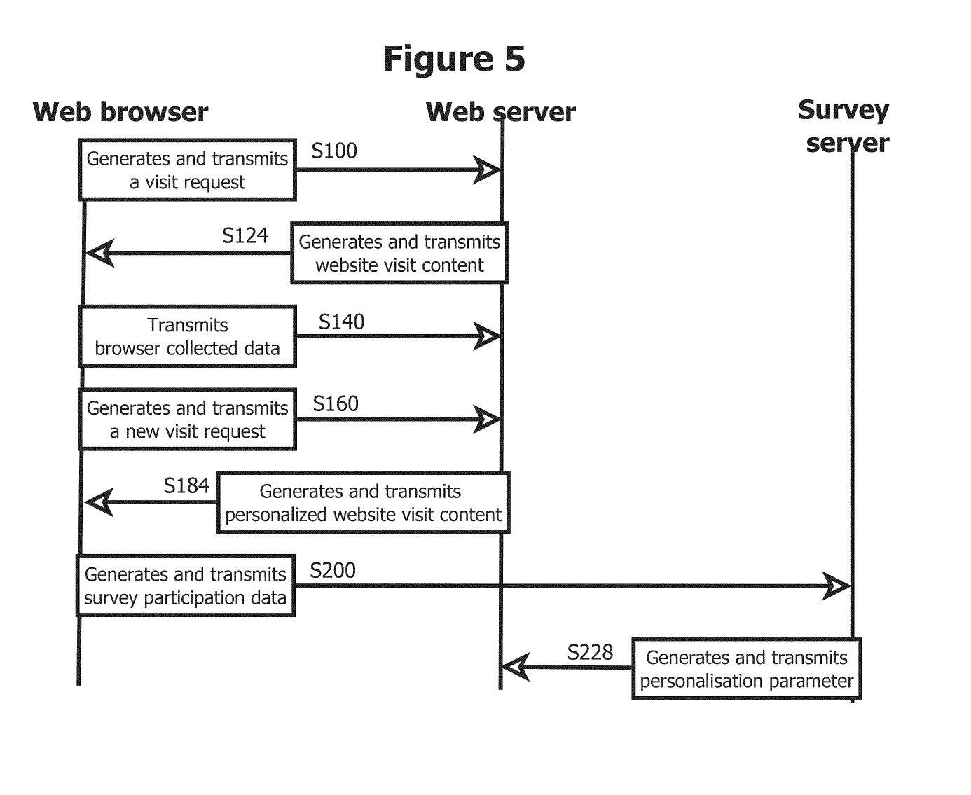

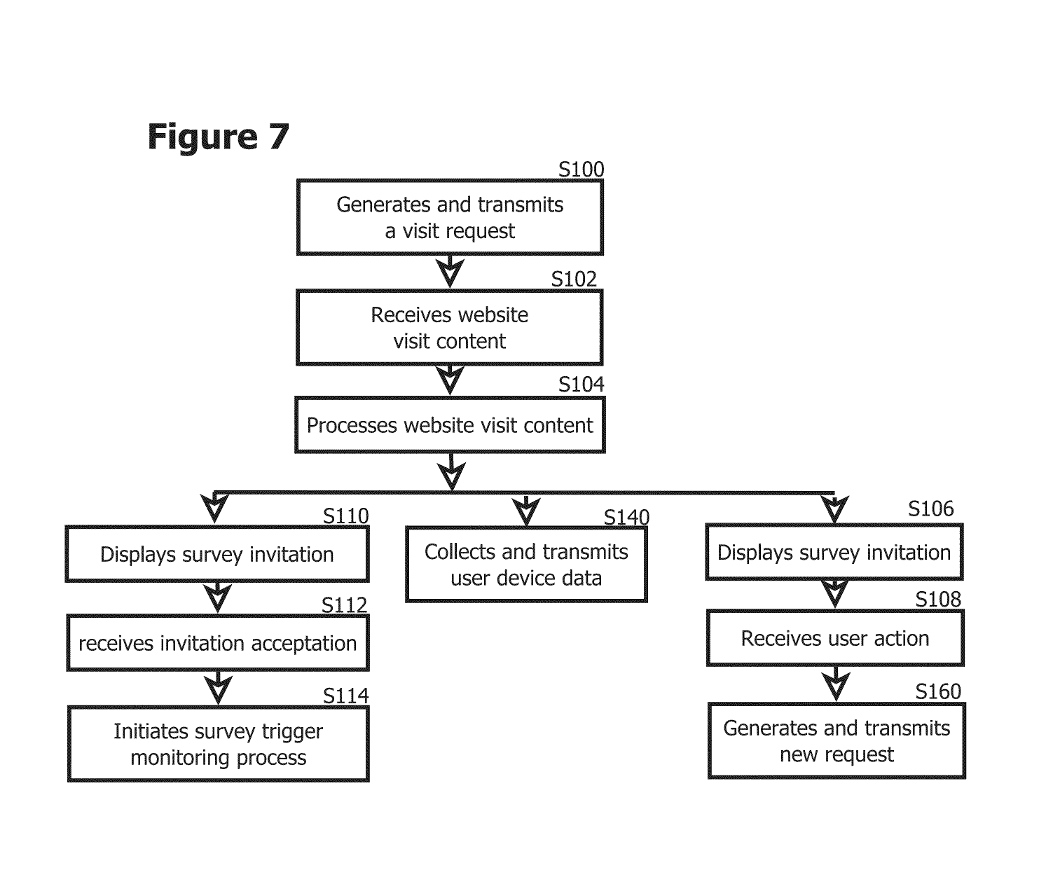

Reference is now made to FIG. 5 and FIG. 7, which depict the method performed on a user device. The method starts at step S100, to generate and transmit a visit request to a web server 30. The visit request, as the following data exchanges, is typically communicated under an Internet communication protocol such as the TCP/IP protocol and characterized by the requested URL. At step S102, website visit content is received from the web server. At step S104, after having received website visit content from the website server in response to the visit request, the user device, according to the web browser runtime environment, processes the HTML document and other received web content such as CSS and the discrete web content to determine format and content of the webpage to be displayed.

At step S140, the method comprises the user device collecting and/or using and transmitting data pertaining to the user device to the web server. Collecting, using and/or transmitting data pertaining to the user device is usually performed without intervention and/or knowledge of the user of the user device. Environmental data collected from the user device such as browser type, device type, display settings, etc. is autonomously processed along with the website visit content to rapidly generate a first webpage to be displayed. Alternatively, the environmental data along with an identifier specific to the user device or user are transmitted to the web server prior to the generation and display of any webpage on the user device. For example, the process of transmitting environmental data and identifier data is performed when the user device, according to instructions embedded in the HTML document in the form of a script, identifies a cookie stored in the user device memory that pertains to the website, and transmits at least part of the cookie content to the web server, including the identifier. Accordingly, the web server is able to associate the communicated identifier to the browsing session for the time it remains active. Alternatively, the user device may wait for signal from the web server in response to the transmission of the identifier to display the webpage associated with the original visit request.

The processing of the web website visit content may include processing HTML-document embedded instructions for instance. Embedded instructions may involve scripts such as Java Scripts, and instructions coded in other languages with respect to the instructions being capable to be processed according to the runtime environment provided by the web browser. The resulting processes, functions and software components are restricted to be performed with respect to the same origin and browsing session security restrictions as the embedding HTML document.

At step S106, the method comprises displaying the webpage on the screen of the user device. At step S104, the method comprises, along processing of other web content, to process HTML-document embedded instructions in relation with the conduct of a survey process. The instructions resulting in conducting the survey process may either be embedded directly in the HTML document, for instance in a Java Script, or may be downloaded afterwards according to other instructions (for instance another script) embedded in the HTML document. An example of the latter is the use of a Tag Management script in collaboration with a Tag Management Server to centralize the management of all scripts relative to a webpage. When such solution is selected, the script pertaining to the Tag Management Server is processed first along with the HTML document. Based on instructions coded in the script, additional scripts are requested by the user device to the Tag Management Server and, once these additional scripts are processed, additional processes are initiated, for example the present survey process.

The method may alternatively comprises displaying either as a new window or as an overlay over the webpage an invitation for the user to participate in a survey. Then, at step S112, the user's response to the invitation is collected, and the invitation window or overlay is closed. Accordingly, a survey process, either or not conditional to user acceptation, is initiated resulting in a survey trigger monitoring process taking place (at step S114) to determine when to initiate the conduct of a participation in the survey.

According to an alternative, the initiation of a participation in a survey may be based simply on a user action requiring no active process of monitoring on the user device, such as a hyperlink included in the HTML document for instance. Regardless of the use of an active or a passive process, the outcome is the same: providing users with a solution to participate in a survey.

At step S160 and back to step S102, the method continues with exchanges between the user device and the web server as a visit of the website takes place. During this visit, beginning either or not with the first webpage visited, and affecting none, some or all of the viewed webpages, the user device receives website visit content from the web server that has been personalized by the web server for the identified user based on the communicated identifier. Accordingly, following the user performing an action triggering a new request (at step S108) such as selecting a hyperlink associated with a new webpage of the website, the website visit continues with a new webpage being requested, communicated and displayed.

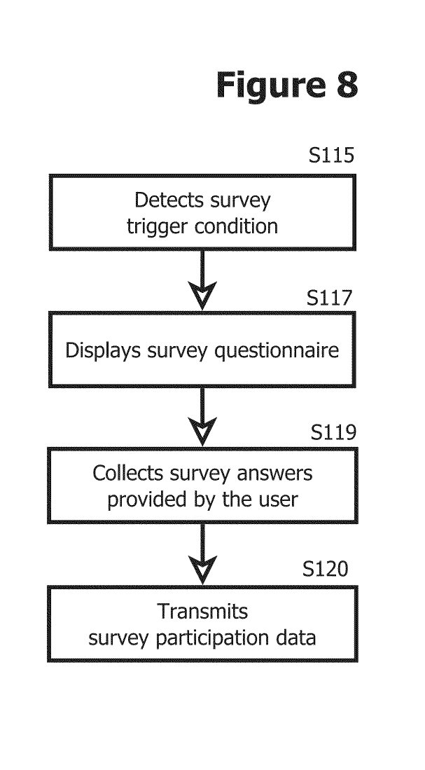

Reference is now made to FIG. 8 illustrating the conduct of a survey participation process on the user device. At step S115, the method comprises initiating the conduct of a survey participation process. As mentioned before, the process may be triggered using an active monitoring process or not. During the survey participation process, the user is displayed a questionnaire (at step S117) and asked to respond to questions pertaining to their visit of the website. Format of the questions may vary from ratings, picks among predetermined terms and expressions, ordering of predetermined terms and expressions, predetermined format answers requiring the survey participant to enter a number for instance, and open-ended comments in which the user is free to provide answers in their own words. At step S119, the method comprises collecting the answers provided by the user as survey participation data. At step S120, the survey participation data are transmitted to a survey server. The transmission is performed according to survey script instructions indicating the address of the survey server to communicate with. One should note that the above steps have been provided in a non-limiting order. For instance, the browsing session during which takes place the website visit is not limited to end with the survey participation process; the visit may continue afterwards. Similarly, some steps may not take place in all browsing sessions. For instance, survey participation process may be limited to a sample of visits, such as following a first visit of a website, and after a predetermined number of visits or a time period since the last participation in the survey.

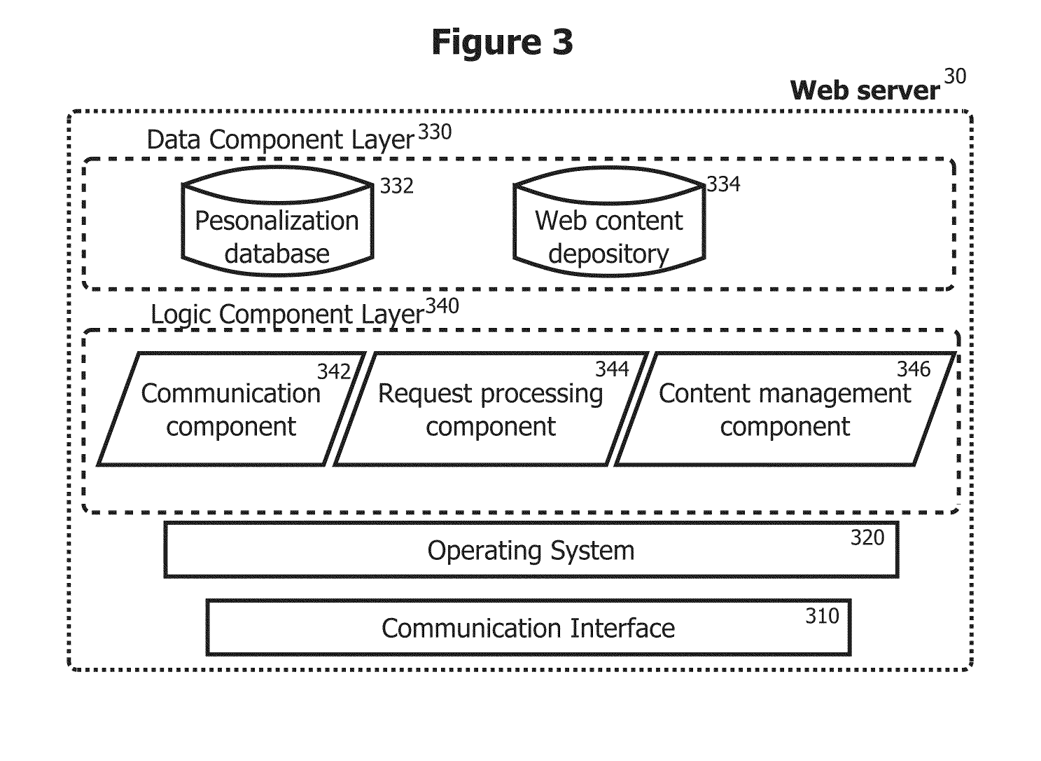

Included in the system, interacting with the user devices 20, is the web server 30. It comprises, as illustrated on FIG. 3, communication interface 310, operating system 320, and memory storing code conceivable as a data component layer 330 (dedicated to data storage) and a logic component layer 340 (dedicated to processes). It comprises among its process-dedicated components a communication component 342 controlling the communications with other processor-based devices, a request processing component 344 handling the processes associated with website visit and other communications with remote processor-based devices and a content management component 346 (also called Web Content Manager—WCM) adapted to generate personalized website visit content by selecting, combining and/or modifying web content stored in the web content depository based on request data and personalization parameters. Also present in the data component layer 330 are a personalization database 332 in which identifiers and personalization parameters are stored and a web content depository 334 wherein web content is stored.

In the present context, one must understand that the term “web server” is taken according to a broad definition, namely a processor-based device performing several functions such as responding to website visit requests, and providing HTML documents and other web content to requesting devices over a network such as the Internet. These processes may be executed by a plurality of devices completing altogether the functions of the described web server, or may involve additional functions while remaining within the broad definition of the term. Communication with the web server is typically performed according to a TCP/IP protocol, but is not limited to that protocol. Similarly, the term “server” must be construed as a processor-based device in communication with other devices over the Internet and able to perform specialized tasks based on exchange of communication with remote processor-based devices over a network such as the Internet.

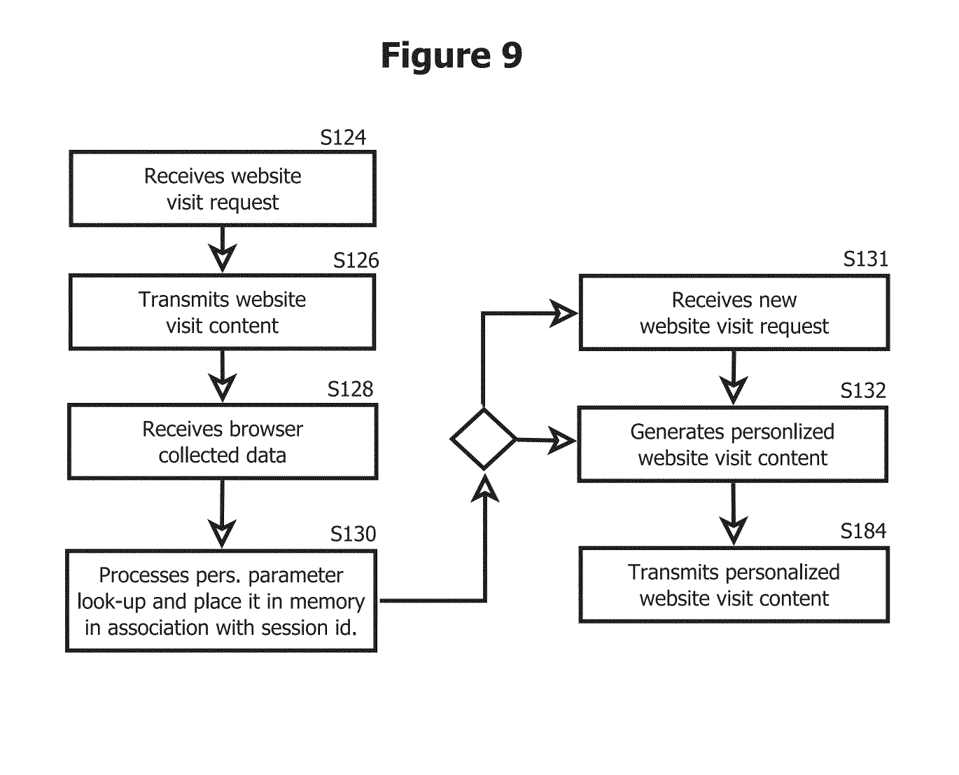

The web server performs the following method (illustrated on FIG. 5 and FIG. 9). At step S124, the web server receives a visit request from a user device. At step S126, the web server transmits to the user device website visit content. That content includes instructions that, when processed by the user device, result in the user device communicating to the web server user-device collected data including (when available) an identifier of the user or user device. The user-device collected data are stored in association of a browsing session identifier in memory of the web server. At step S128, the web server receives user-device data collected from the user device used to identify the web browser or the user of the web browser. At step S130, the web server performs a lookup in the personalization database to extract a personalization parameter associated with the identifier. At step S132, the web server assembles and/or generates a personalized website visit content to be transmitted to the user device. The personalized website visit content is composed of a combination of HTML document with optionally a Content Style Sheet and discrete web content. Generating the personalized website visit content (S132) and transmitting the personalised website visit content (S184) may begin with the first webpage of the visit, or be delayed to following webpage requests. Personalized website visit content, as illustrated on FIG. 6, is characterized in at least one of: 1) the HTML document 602, 2) the content style sheet 604 and 3) the discrete web content 606 being either a) selected among a plurality of available ones or b) generated specifically according to the personalization parameter. Personalized website visit content may also include instructions or scripts 608 that may be selected specifically based on personalization parameters. All the above content is stored in the web content depository 334. Generating specific web content may take the form of modification of a standard web content, combination of many web contents into a single one, or addition of instructions in the web content for instance. Accordingly, a personalized website visit content differ from a generic (not personalized) one either in its presentation as a webpage or in the undergoing processes it triggers when processed by a processor of the user device and in accordance with the web browser Runtime environment. Therefore, depending on personalization parameters used for generating website visit content, users will not have an identical experience even though the webpage generated and displayed result from identical visit requests. The personalization process 614, according to a personalization algorithm 612, is performed by the content management component 346 (shown on FIG. 3). FIG. 6 schematically illustrates 3 potential personalized webpages (616a, 616b and 616c) different according to content (616a versus 616c) or according to presentation (616a versus 616b).

Once generated, at step S184, the personalized website visit content is transmitted to the user device. At step S131, the web server receives a new page request from the same user device according to the same browsing session. At step S132, the web server repeats the process of generating a personalized website visit content in response to the new request, using the personalization parameter associated with the browsing session identifier stored in memory. This new personalized website visit content is once again transmitted to the user device at step S184.

Additionally, the web server may update a profile database (not illustrated) by establishing a communication with a survey server 40 (shown on FIG. 1). Establishing the communication may be initiated by any or both the web server 30 and the survey server 40, and/or either scheduled, triggered, or performed under the control of a representative of any of the parties.

The web server 30 receives from the survey server 40 personalization data comprising at least one set of identifier and personalization parameter. In other words, the survey server 40 transmits to the web server 30 data enabling the web server 30 to identify with which user device or user the associated parameter should be set to. The web server 30 updates the personalization database according to the personalization data received from the survey server.

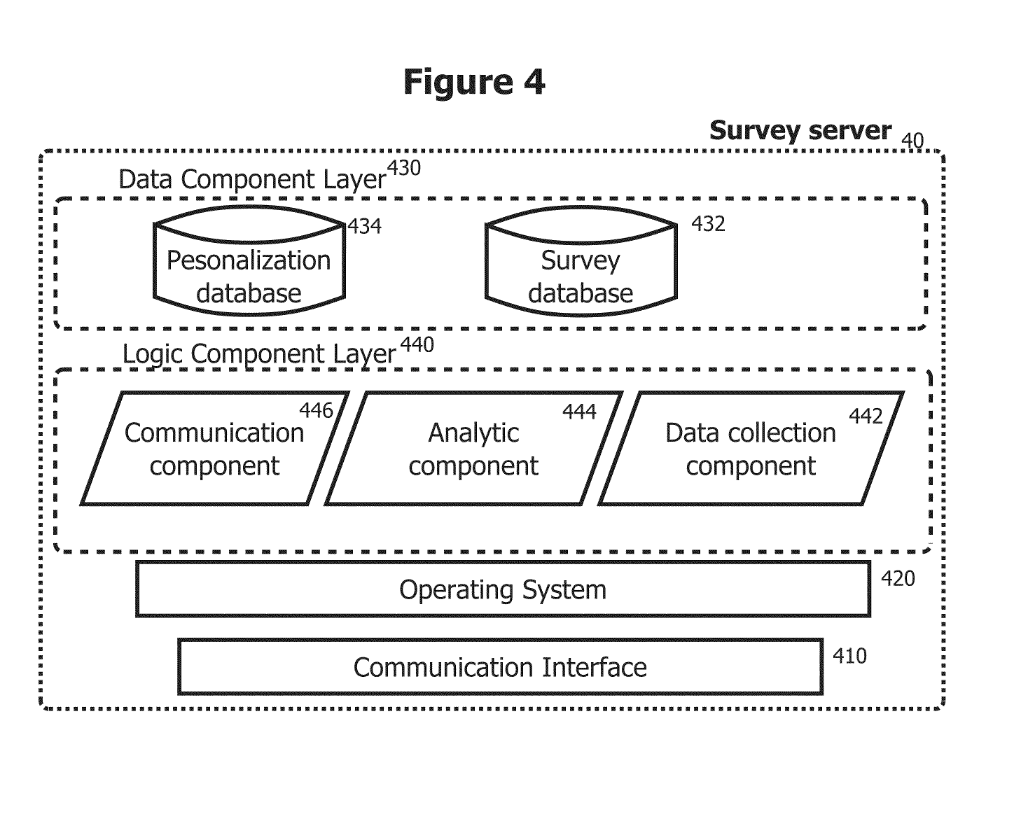

The survey server 40 (illustrated on FIG. 4), comprises a communication interface 410, an operating system 420, and memory storing code corresponding to a data component layer 430 (dedicated to data storage) and a logic component layer 440 (dedicated to processes). The data component layer 430 is used to store the survey participation data (in a survey database 432) and, personalization parameters associated with identifiers (in a personalization database 434). The logic component layer 440 comprises, once the instructions present in the code are processed, the following components: a data collecting component 442 (survey collecting component) used to collect the survey participation data from web browsers and to store the survey data in the survey database 432; an analytic component 444 analysing the collected data to generate personalization parameters and to store the generated personalization parameters in a personalization database 434 along with identifiers permitting to associate the personalization parameters with specific users or user devices; and a communication component 446 taking charge of communications, including exchange with web browsers and the transmission of the outcome generated by the analytic component to the web server.

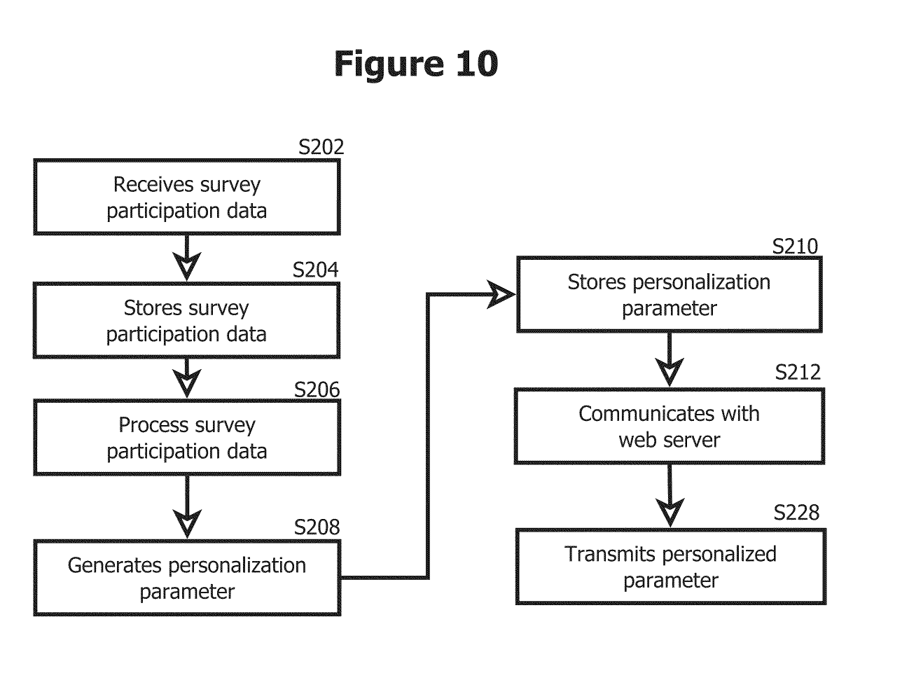

The method performed by the survey server 40, illustrated on FIG. 5 and FIG. 10. At step S202, the data collecting component 442 of the survey server, in collaboration with the communication component 446, receive survey participation data from user devices, and, at step S204, store the survey participation data in the survey database 432. Typically, the survey participation data is received over a time period from a plurality of user devices in an asynchronous manner. The survey participation data are stored along with an identifier (either identifying the browsing session or the user device or user) in the survey database 432.

At step S206, the analytic component 444 of the survey server analyses the survey participation data to determine personalization parameters to associate with each survey participation. Additional parameters may also be taking into account during the determination of personalization parameters, including a previously determined personalization parameter associated with the survey participant, a series of personalization parameters defined according to survey participation data provided by a plurality of survey participant, or the survey participation data itself provided by that population of survey participants. The method continues, at step S208, with storing the newly-generated personalization identifiers in the personalization database 434.

Now referring to FIG. 6, the algorithm applicable 612 to determine the personalization parameters 616 may vary. For instance, in a first example the survey participation data includes a set of ratings provided by the user in relation with purposes of visit, appreciation of the visit, expectations in terms of search time, loading time, etc. and the algorithm 612 is used to determine details and light-weight parameters that should respond to the user ratings. Alternatively, the analytic component 444 may pass comments provided by the user in a free form in natural language processing component in order to extract metrics from the analysis, and afterwards determines personalization parameters based on these extracted metric.

The method may also comprise the survey server 40 establishing communication with the web server 30 to obtain correspondences between session identifiers and user identifiers, and may comprise the survey server receiving from the user devices the same identifiers used by the web server, or the survey server may simply use the browser session identifier as user identifier.

At step S212, the method comprise the communication component 446 of the survey server 40 establishing communication with the web server 30, and transmitting, at step S228) at least part of the personalization data stored in the personalization database to the web server 30. The survey server 40 may transmit the whole content of the personalization data pertaining to the website, or data relative to only newly generated personalization parameters to the web server 30. When only newly generated personalization parameters are transmitted, the personalization database 434 is adapted to store personalization parameter generation time, and time of the last transmission of personalization parameters to the web server 30.

The survey server 40 may also receive additional data such as browsing environment data from user devices, geo-locations collected based on identification of the IP address of the user devices or user-device communicated data, and click stream data received either from the user device or from a third party such as a web analytic server such as Google Web Analytic™ and take them into account when determining personalization parameters.

The personalization parameter may vary from one website to another. For instance, the personalization parameter may simply consist in a segment identification (ex: beginning/intermediate/advanced, search/support/buy, etc.) according to which is processed the user visit request to provide personalized website visit content. The survey server may instead list a series of parameters to take into account for personalization (ex. preferences, sensibility ratings to webpage processing time, to animations, to webpage lengths, to advertising, etc.). According to the business to which pertains the website, the nature of services offered by the website, etc., the selection of the parameters and their nature may change.

Furthermore, the personalization rules, applied by the survey server 40 to set personalization parameters or applied by the web server to generate personalized website visit content, may take a combination of types of collected data into account including for example: demographic data collected from users, user device type and location collected from user devices, behavioral data (also called click stream) collected from the web browsers of the user devices, transaction history collected from web servers, etc. Accordingly, data collected and used to generate personalized web content may be divided in the following categories: 1—electronically generated data which may be defined as anything that can be electronically collected from the user device or is generated according to events performed by users on user devices, and 2—survey data which may be defined as opinions and other personal suggestive information based on, for instance, emotion that are provided by users.

The web server 30 and the survey server 40 could be combined in a single processor-based device. The combined web/survey server (not illustrated) would comprise communication interface, operating system, and memory storing code conceivable as a data component layer (dedicated to data storage) and a logic component layer (dedicated to processes). The combined web/survey server would comprise a communication component controlling the communications with other processor-based devices. The combined web/survey server would comprise a request processing component handling the processes associated with website visit and other communications with remote processor-based devices. The combined web/survey server would comprise a personalization database in which identifiers and personalization parameters are stored. The combined web/survey server would comprise a web content depository wherein web content is stored. The combined web/survey server would comprise a content management component adapted to generate personalized website visit content by selecting, combining and/or modifying web content stored in the web content depository based on request data and personalization parameters. The combined web/survey server would further comprise a data collecting component (survey collecting component) used to collect the survey participation data from web browsers and to store the survey data in the survey database, and an analytic component analysing the collected data to generate personalization parameters and to store the generated personalization parameters in a personalization database along with identifiers permitting to associate these personalization parameters with specific users or user devices.

The method performed by the combined web/survey server starts at step S124, the combined web/survey server receives a visit request from a user device 20. At step S126, the combined web/survey server transmits to the user device 20 the website visit content. At step S128, the combined web/survey server receives an identifier from the user device 20. At step S130, the combined web/survey server performs a lookup verification for the identifier in its personalization database 332. At step S131, the combined web/survey server, may optionally provide personalized website visit content starting with the second request, receives an additional request from the user device 20 with respect to the same browsing session. At step S132, the combined web/survey server generates a personalized web content in response to the additional request. At step S184, the combined web/survey server transmits the personalized web content to the user device 20. At step S202, the combined web/survey server receives survey participation data from the user device 20. At step S206, the combined web/survey server analyses the survey participation data and, at step S208, determines the personalization parameter to store in the personalization data according to the associated identifier.

The method may alternatively further comprise the web server receiving from the user device additional data (click stream data, browsing environment data, etc.) and performing the determination of the personalization parameter S208 further in view of the additional data. The method further determines the personalization parameter in view of the personalization parameter used to generate the personalized website visit content during the browsing session for which the survey participation data has been received. Although not shown, the web server may also receive click stream data from the user device, and determine the personalization parameter further in view of the click stream generated by the user during the visit of the website.

Accordingly, the personalized parameter may be determined based solely on the survey participation data, or in combination of any one or more of 1—previously determined personalization parameters, 2—environmental data transmitted by user devices, and 3—click stream data. The personalization parameters determined based on these data may, as described earlier, either be composed of a single element or a combination thereof.

Although the present system and method have been described in the foregoing description by way of the provided illustrative embodiments, these embodiments are not intended to limit the scope of the appended claims.

What I/We claim is:

1. A method performed on a processor-based web server, comprising:
a request processing component receiving, from a remote user device hosting a web browser, a request to visit a website;
a communication component exchanging data with the remote user device to obtain a recognisable identifier from the remote user device;
after reception of the recognisable identifier, a content management retrieving from a personalization database a personalization parameter associated with the recognisable identifier;
the content management component generating, according to a database of web contents and the personalization parameter, a personalized website visit content comprising one of: 1) a different HTML document, 2) a different Cascading Style Sheet (CSS), and 3) a different web content to be provided according to the HTML document, than a non-personalized webpage; and
the communication component transmitting the personalized website visit content to the remote user-device.

2. A web-server-implemented method, comprising:
receiving, from a remote user device hosting a web browser, a request to visit a website;
exchanging data with the remote user device to obtain a recognisable identifier from the remote user device;
after reception of the recognisable identifier, retrieving from a personalization database a personalization parameter associated with the recognisable identifier;
generating, according to a database of web contents and the personalization parameter, a personalized website visit content comprising one of: 1) a different HTML document, 2) a different Cascading Style Sheet (CSS), and 3) a different web content to be provided according to the HTML document, than a non-personalized webpage; and
transmitting the personalized website visit content to the remote user-device.

3. A computer program product comprising a computer readable memory storing computer executable instructions thereon that when executed by a web server processor performs the steps of:
receiving, from a remote user device hosting a web browser, a request to visit a website;
exchanging data with the remote user device to obtain a recognisable identifier from the remote user device;
after reception of the recognisable identifier, retrieving from a personalization database a personalization parameter associated with the recognisable identifier;
generating, according to a database of web contents and the personalization parameter, a personalized website visit content comprising one of: 1) a different HTML document, 2) a different Cascading Style Sheet (CSS), and 3) a different web content to be provided according to the HTML document, than a non-personalized webpage; and
transmitting the personalized website visit content to the remote user-device.

4. A method performed on a processor-based survey server, comprising:
a data collection component of the survey server receiving survey participation data in which a survey participant has provided opinions on an experience of visit of a website from a remote user device under control of a survey participant;
an analytic component of the survey server processing the survey participation data to generate a personalization parameter to be associated with the survey participant; and
a communication component of the survey server transmitting to a web server, which is responsible of visits of the website and which comprises a content management component, the personalization parameter with an identification of either a) the user device which transmitted the survey participation data, b) identification of the browsing session to which the survey participation data pertains, and c) identification of the user who participated in the survey.

5. The method of claim 4, further comprising:
retrieving a previously-stored personalization parameter associated with the survey participant;
Wherein the processing of the survey participation data is performed further in view of the previously-stored personalization parameter.

6. The method of claim 4, wherein the survey participation data comprises responses to opinion requests provided by the survey participant with regard of their website visit experience.

7. The method of claim 4, further comprising performing a segment determination based on survey participation data.

8. A survey-server-implemented method, comprising:
a data collection component of the survey server receiving survey participation data in which a survey participant has provided opinions on an experience of visit of a website from a remote user device under control of a survey participant;
an analytic component of the survey server processing the survey participation data to generate a personalization parameter to be associated with the survey participant; and
a communication component of the survey server transmitting to a web server, which is responsible of visits of the website and which comprises a content management component, the personalization parameter with an identification of either a) the user device which transmitted the survey participation data, b) identification of the browsing session to which the survey participation data pertains, and c) identification of the user who participated in the survey.

9. A computer program product comprising a computer readable memory storing computer executable instructions thereon that when executed by a survey-server processor performs the steps of:
a data collection component of the survey server receiving survey participation data in which a survey participant has provided opinions on an experience of visit of a website from a remote user device under control of a survey participant;
an analytic component of the survey server processing the survey participation data to generate a personalization parameter to be associated with the survey participant; and
a communication component of the survey server transmitting to a web server, which is responsible of visits of the website and which comprises a content management component, the personalization parameter with an identification of either a) the user device which transmitted the survey participation data, b) identification of the browsing session to which the survey participation data pertains, and c) identification of the user who participated in the survey.

10. A survey conducting system comprising:
a processor;
a communication interface for communicating with remote processor-based devices through a communication network; and
memory storing one or more databases, and program code responsible, when processed by the processor, for the execution of the following components of the survey conducting system:
a survey participation collection component that:
receives from remote processor-based devices under control of survey participants survey participation data, the survey participation data pertaining to visits of a website; and
stores the survey participation data in a survey database;
a personalization analytic component that:
processes the survey participation data;
generates a personalization parameter to be associated with the survey participant who provided the survey participation data accordingly; and
stores the personalization parameter in a personalization database; and
a parameter communication component that:
communicates to the web server responsible for providing visits of the website the personalization parameter along an identifier usable by the web server to identify the survey participant.
